(19) United States
(12) Patent Application Publication
(10) Pub. No.: US 2006/0146044 A1
(43) Pub. Date: Jul. 6, 2006

(54) Flat discharge lamp and plasma display panel (PDP)

(76) Inventors: Hidekazu Hatanaka, Suwon-si (KR); Gi-Young Kim, Suwon-si (KR); Young-Mo Kim, Suwon-si (KR); Seong-Eui Lee, Suwon-si (KR); Ho-Nyeon Lee, Suwon-si (KR); Seung-Hyun Son, Suwon-si (KR); Sang-Hun Jang, Suwon-si (KR); Hyoung-Bin Park, Suwon-si (KR)

Correspondence Address: Robert E. Bushnell, Suite 300, 1522 K Street, N.W., Washington, DC, 20005-1202, US

(21) Appl. No.: 11/290,537

(22) Filed: Dec. 1, 2005

(30) Foreign Application Priority Data
Dec. 30, 2004 (KR) 10-2004-0117011

(51) Int. Cl. G09G 5/00

(52) U.S. Cl. 345/211

(57) ABSTRACT

A low-discharge-voltage high-brightness high-efficiency flat discharge lamp includes: a container; first and second electrodes arranged in the container, the second electrode including a plurality of discharge elements having different respective discharge distances with respect to the first electrode; and at least one discharge delay element respectively electrically connected to at least one of the plurality of discharge elements, each of the at least one discharge delay elements having different delay times. A high-brightness low-discharge-voltage high-efficiency PDP includes: a discharge space; first and second electrodes arranged in the discharge space, the second electrode including a plurality of discharge elements having different discharge distances with respect to the first electrode; and at least one discharge delay element respectively electrically connected to at least one of the discharge elements, each of the at least one discharge delay elements having different delay times. Accordingly, it is possible to initiate a discharge at a low discharge voltage and sustain a long-distance discharge.

### CLAIM OF PRIORITY

This application makes reference to, incorporates the same herein, and claims all benefits accruing under 35 U.S.C.§119 from an application entitled FLAT LAMP AND PLASMA DISPLAY PANEL, earlier filed in the Korean Intellectual Property Office on 30 Dec. 2004 and there duly assigned Serial No. 10-2004-0117011.

### BACKGROUND OF THE INVENTION

1. Field of the Invention

The present invention relates to a flat discharge lamp and a Plasma Display Panel (PDP), and more particularly, to a low-discharge-voltage high-efficiency flat discharge lamp and PDP.

2. Description of the Related Art

Plasma Display Panels (PDPs) are classified into facing and surface discharge PDPs. The present invention particularly relates to surface discharge PDPs. Surface discharge PDPs are disclosed in U.S. Pat. Nos. 4,638,218 and 5,661,500. In a surface discharge PDP, a pair of discharge sustaining electrodes is provided on the same front substrate, and discharge is generated between two electrodes in the direction parallel to the front substrate.

The discharge generated in the direction parallel to the substrate is called the surface discharge. In the surface discharge PDP, the discharge sustain electrodes are provided on the front substrate, light passing portions are made of a light transparent material such as Indium Tin Oxide (ITO). The ITO is a transparent conductive material used for transparent electrodes. Since it has a high resistance, the light transparent material such as ITO is partially used in the plasma discharge region. Bus lines made of a low-resistance metal is used to transmit signals to the ITO electrodes.

A PDP includes first and second substrates. A plurality of discharge sustain electrode pairs are disposed on an inner surface of the first substrate. The discharge sustain electrodes are made of a transparent material. A dielectric layer and a protective layer are stacked in this order to cover the discharge sustain electrodes. A plurality of barrier ribs are provided over an inner surface of the second substrate in the direction perpendicular to the discharge sustain electrodes. A plurality of address electrodes are disposed on the inner surface of the second substrate between the barrier ribs. A dielectric layer is provided to cover the address electrodes. Fluorescent layers are coated on side walls of the barrier ribs and upper surfaces of the dielectric layer between the barrier ribs. The discharge sustain electrodes are disposed in the direction perpendicular to the address electrodes and the barrier ribs.

In the surface discharge PDP, an initial discharge is generated by one discharge sustain electrode and one address electrode. The discharge is then sustained by the discharge sustain electrodes. Ultra-violet (UV) light emitted by a discharge region irradiates the fluorescent layers. Visible light is emitted from the excited fluorescent layers. The visible light is used for illumination by the flat discharge lamp or for display by the PDP.

In such a PDP, the discharge distance is short, and there is a limitation as to the electrode arrangement. Therefore, the discharge efficiency of such a PDP is disadvantageously low. In addition, since the discharge is generated close to the first substrate (front substrate), plasma ions collide with the protective layer. Therefore, the protective layer can rapidly deteriorate, so that lifetime of the PDP is shortened. On the other hand, the fluorescent layers are separated from the second substrate (rear substrate) by a relatively long distance. Therefore, a relatively large amount of the UV light emitted by the discharge region of the first substrate is not absorbed by the fluorescent layers. As a result, the brightness of the PDP is reduced.

The lengthening of the discharge distance in the limited discharge space is one of the main development subjects for the flat discharge lamp as well as the PDP. Since there is a limitation to the discharge space, it is difficult to design the flat discharge lamp and the PDP. On the other hand, the lengthening of the discharge distance results in increase in the discharge voltage. In case of lengthening of the discharge distance in the limited discharge space, the reducing of the discharge voltage must be taken into consideration.

Therefore, there is a need for a discharge mechanism used for a low-discharge-voltage high-brightness high-efficiency flat discharge lamp or PDP.

### SUMMARY OF THE INVENTION

The present invention provides a low-discharge-voltage high-brightness high-efficiency flat discharge lamp or Plasma Display Panel (PDP).

The present invention also provides a low-discharge-voltage high-brightness high-efficiency flat discharge PDP.

According to one aspect of the present invention, a flat discharge lamp is provided including: a container; first and second electrodes arranged in the container, the second electrode including a plurality of discharge elements having different respective discharge distances with respect to the first electrode; and at least one discharge delay element respectively electrically connected to at least one of the plurality of discharge elements, each of the at least one discharge delay elements having different delay times.

The at least one discharge delay element includes a magnetic switch.

A discharge delay element having a longest delay time is preferably electrically connected to a discharge element having a greatest discharge distance with respect to the first electrode.

The discharge delay elements are preferably respectively electrically connected to the plurality of discharge elements such that the delay times of the discharge delay elements are proportional to the discharge distances with respect to the first electrode of the plurality of discharge elements.

According to another aspect of the present invention, a Plasma Display Panel (PDP) is provided including: a discharge space; first and second electrodes arranged in the discharge space, the second electrode including a plurality of discharge elements having different discharge distances with respect to the first electrode; and at least one discharge delay element respectively electrically connected to at least one of the discharge elements, each of the at least one discharge delay elements having different delay times.

The at least one discharge delay element preferably includes a magnetic switch.

A discharge delay element having a longest delay time is preferably electrically connected to a discharge element having a greatest discharge distance with respect to the first electrode.

The discharge delay elements are preferably respectively electrically connected to the plurality of discharge elements such that the delay times of the discharge delay elements are proportional to the discharge distances with respect to the first electrode of the plurality of discharge elements.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a schematic perspective view of a Plasma Display Panel (PDP);

FIG. 2 is a schematic cross-sectional view of the PDP of FIG. 1;

FIG. 3 is a view of a discharge mechanism according to an embodiment of the present invention;

FIG. 4 is a perspective view of a magnetic switch used for the discharge mechanism according to an embodiment of the present invention;

FIG. 5 is a schematic cross-sectional view of a flat discharge lamp according to an embodiment of the present invention;

FIG. 6 is a schematic perspective view of a PDP according to another embodiment of the present invention; and

FIG. 7 is a schematic cross-sectional view of the PDP of FIG. 6.

### DETAILED DESCRIPTION OF THE INVENTION

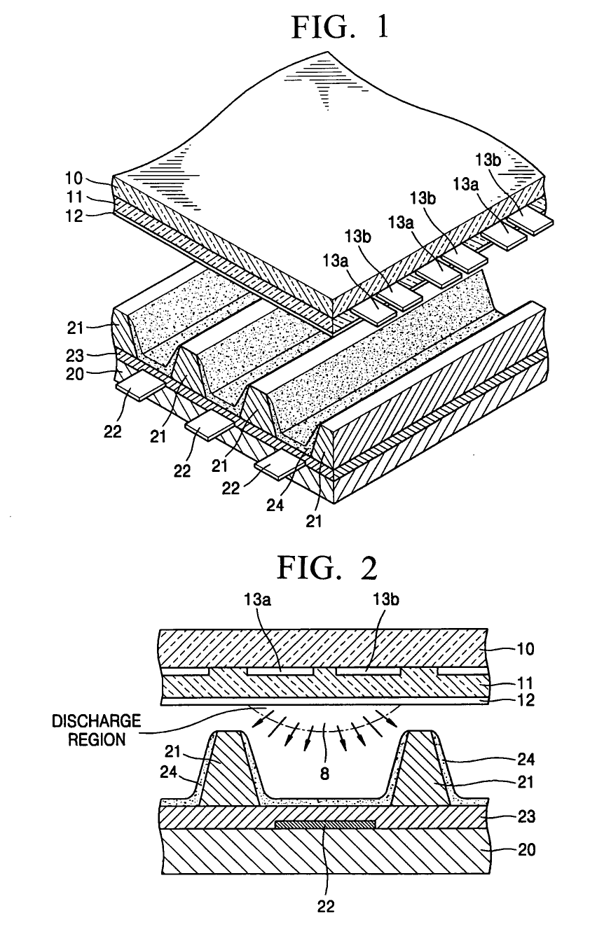

FIG. 1 is a schematic perspective view of a Plasma Display Panel (PDP). FIG. 2 is a schematic cross-sectional view of the PDP of FIG. 1.

The PDP includes first and second substrate 10 and 20. A plurality of discharge sustain electrode pairs 13a and 13b are disposed on an inner surface of the first substrate 10. The discharge sustain electrodes 13a and 13b are made of a transparent material. A dielectric layer 11 and a protective layer 12 are stacked in this order to cover the discharge sustain electrodes 13a and 13b. A plurality of barrier ribs 21 are provided over an inner surface of the second substrate 20 in the direction perpendicular to the discharge sustain electrodes 13a and 13b. A plurality of address electrodes 22 are disposed on the inner surface of the second substrate 20 between the barrier ribs 21. A dielectric layer 23 is provided to cover the address electrodes 22. As shown in FIG. 2, fluorescent layers 24 are coated on side walls of the barrier ribs 21 and upper surfaces of the dielectric layer 23 between the barrier ribs 21. As shown in FIG. 1, the discharge sustain electrodes 13a and 13b are disposed in the direction perpendicular to the address electrodes 22 and the barrier ribs 21. However, in FIG. 2, in order to show all the components in the single figure, the discharge sustain electrodes 13a and 13b are depicted in a direction parallel to the address electrodes 22 and the barrier ribs 21.

In the surface discharge PDP, an initial discharge is generated by one discharge sustain electrode and one address electrode. The discharge is then sustained by the discharge sustain electrodes 13a and 13b. Ultra-violet (UV) light emitted by a discharge region 8 irradiates the fluorescent layers 24. Visible light is emitted from the excited fluorescent layers 24. The visible light is used for illumination by the flat discharge lamp or for display by the PDP.

In such a PDP, the discharge distance is short, and there is a limitation as to the electrode arrangement. Therefore, the discharge efficiency of such a PDP is disadvantageously low. In addition, since the discharge is generated close to the first substrate (front substrate) 10, plasma ions collide with the protective layer 12. Therefore, the protective layer 12 can rapidly deteriorate, so that lifetime of the PDP is shortened. On the other hand, the fluorescent layers 24 are separated from the second substrate (rear substrate) 20 by a relatively long distance. Therefore, a relatively large amount of the UV light emitted by the discharge region 8 of the first substrate 10 is not absorbed by the fluorescent layers 24. As a result, the brightness of the PDP is reduced.

A flat discharge lamp and a Plasma Display Panel (PDP) according to embodiments of the present invention are described in detail below with reference to the accompanying drawings.

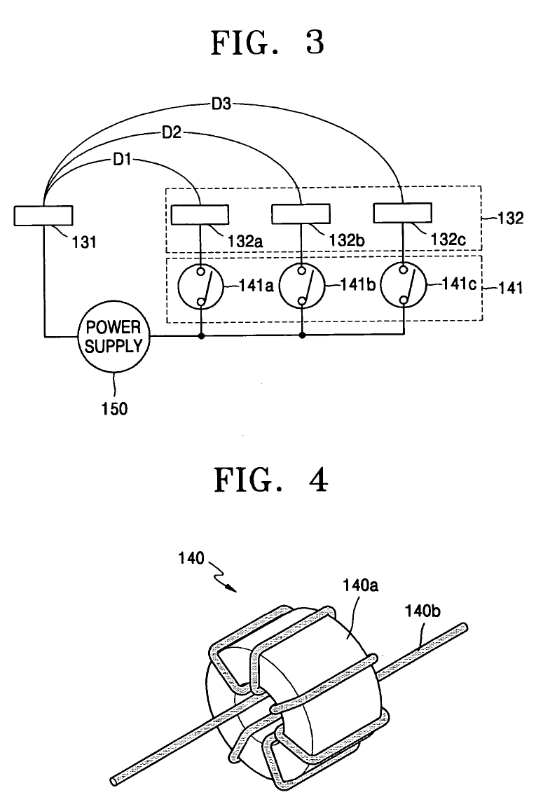

FIG. 3 is a view of a discharge mechanism according to an embodiment of the present invention.

The flat discharge lamp (or the PDP) according to an embodiment of the present invention includes first and second electrodes 131 and 132 separated from each other. The second electrode 132 includes a plurality of discharge elements 132a to 132c.

A power supply 150 is connected to the first and second electrodes 131 and 132. A discharge delay unit 141 is connected to the discharge elements 132a, 132b, and 132c of the second electrode 132. The discharge delay unit 141 delays discharges of the discharge elements 132a, 132b, and 132c.

The discharge delay unit 141 includes discharge delay elements 141a, 141b, and 141c connected to the respective discharge elements 132a, 132b, and 132c.

The discharge elements 132a, 132b, and 132c are separated from the first electrode 131 by different distances. The discharge delay elements 141a, 141b, and 141c delay discharges D1, D2, and D3 of the discharge elements 132a, 132b, and 132c by different delay times, so that the closer discharge element initiates a discharge earlier than the further away discharge element. Namely, the closest discharge element 132a first initiates a discharge, and the furthest away discharge element initiates the last discharge. Therefore, the discharges D1, D2, and D3 are initiated in this order.

The discharge delay elements 141a, 141b, and 141c can include a magnetic switch or a semiconductor switch, which is generally used for a PDP or discharge lamp. The semiconductor switch is arranged on a circuit board. The magnetic switch is constructed with an inductor. The magnetic switch delays the discharge with a discharge delay time, that is, a voltage maintaining time T_{H} described later.

The discharge D1 is first generated by the closest discharge element 132a at the lowest discharge voltage with a low discharge efficiency. Charged particles such as plasma ions generated in the discharge D1 enable the second discharge element 132b to easily generate the subsequent discharge D2. In turn, the charged particles generated in the discharges D1 and D2 also enable the third discharge element 132c to easily generate the subsequent discharge D3. Here, since the third discharge element 132c has the longest discharge distance, the discharge efficiency of the discharge D3 is highest.

In the present invention, an initial discharge is generated by a shortest-discharge-distance discharge element (the closest discharge element), and then, the subsequent discharges are generated. As a result, it is possible to obtain a high-efficiency discharge.

FIG. 4 is a perspective view of the magnetic switch used for the discharge mechanism according to an embodiment of the present invention. The magnetic switch is a kind of choke. The magnetic switch includes a ring-type core 140a and a wire 140b wound around the ring-type core 140a. The discharge delay time, that is, the voltage maintaining time T_{H} obtained by the magnetic switch is represented by Equation 1 below.

$$\begin{matrix}{\int }_{}^{{T}_{H}} V ( t ) ⅆ t = Am \cdot Nt \cdot Δ B & Equation 1 \\ {L}_{MS} = {μ}_{r} {μ}_{o} \frac{Am}{Im} {Nt}^{2} & Equation 2 \\ {V}_{MS} = - {L}_{MS} \frac{ⅆ l}{ⅆ t} & Equation 3\end{matrix}$$

The ring-type core 140a and the wire 140b constitute an inductor that is the magnetic switch. The ring-type core 140a is made of a ferromagnetic material. The wire 140b is made of a conductor. The inductor's inductance L_{MS} is represented by Equation 2 below. A counter electromotive force V_{MS} induced to the inductor is represented by Equation 3 below. The counter electromotive force V_{MS} is proportional to the relative permeability of the inductor. The counter electromotive force V_{MS} changes according to the change of relative permeability. The magnetic switch is a device using the change in the counter electromotive force V_{MS} according to the change in the relative permeability μᵣ after the voltage maintaining time T_{H} of the Equation 1.

Here, μᵣ is a relative permeability, μ₀ is a permeability in vacuum, V(t) is an applied voltage, Am is a magnetic cross-sectional area, Nt is turns of wire, B is a magnetic flux density, ΔB is a change in the magnetic flux density B, lm is a magnetic length, and di/dt is a current change rate.

In addition, the magnetic switch is a passive device. Therefore, at the time of designing the magnetic switch, an operating timing of the magnetic switch must be taken into consideration. The operating time can be defined by the magnetic field intensity proportional to the current flowing through the inductor, that is, the magnetic switch. In particular, since the operating timing cannot be externally controlled, the operating time must be determined at the time of designing the magnetic switch. More specifically, the operating time is determined by the voltage maintaining time T_{H} of Equation 1.

According to an experiment, an inductor having an inductance of 8.1 μH has a delay time of about 5 μs at a voltage of 3 kV. In the experiment, the magnetic cross-sectional area Am is 3 cm², the turns of wire Nt is 500, the change ΔB in magnetic field density is 0.1 T, and the magnetic length lm is 11.6 cm.

By taking the delay time, that is, the voltage maintaining time T_{H} into consideration, the inductances of the discharge delay elements 141a, 141b, and 141c are suitably adjusted.

When using the magnetic switches (inductors) as a discharge element, the magnetic switches are manufactured separately from the discharge lamp or the PDP. The discharge delay elements, that is, the inductors, are then mounted on the discharge delay lamp or the PDP. When using the semiconductor switches as a discharge element, the semiconductor switches are formed on the discharge lamp or the PDP together with other circuit element.

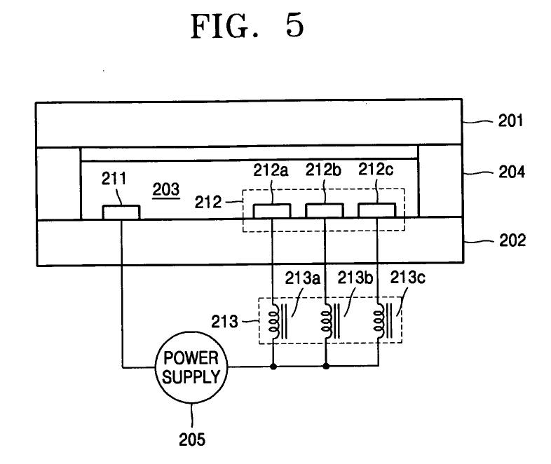

FIG. 5 is a schematic cross-sectional view of a flat discharge lamp according to an embodiment of the present invention.

The flat discharge lamp includes first and second substrates 201 and 202 which define a discharge space 203. First and second discharge electrodes 211 and 212 are disposed on an inner surface of the second substrate 202 within the discharge space 203.

The first and second electrodes 211 and 212 are separated from each other. The second electrode 212 is divided into three discharge elements 212a, 212b, and 212c. A discharge delay unit 213 is coupled to the discharge elements 212a, 212b, and 212c of the second electrode 212. The discharge delay unit 213 includes discharge delay elements 213a, 213b, and 213c coupled to the respective discharge elements 212a, 212b, and 212c. The discharge delay elements 213a, 213b, and 213c are constructed with inductors having different inductances and voltage maintaining times T_{H}. A power supply 205 is connected to the first electrodes 211 and the discharge delay element 213. Alternatively, in another embodiment, a dielectric layer (not shown) covers the first and second electrodes 211 and 212.

Although a single one discharge space 203 is provided in the embodiment of FIG. 5, the discharge space can be partitioned into a plurality of discharge spaces. In this case, a plurality of first and second electrodes are provided to the respective discharge spaces. On the other hand, since the closest discharge element 212a first initiates a discharge, the discharge need not be delayed. Therefore, the discharge delay element 213a coupled to the closest discharge element 212a can be omitted.

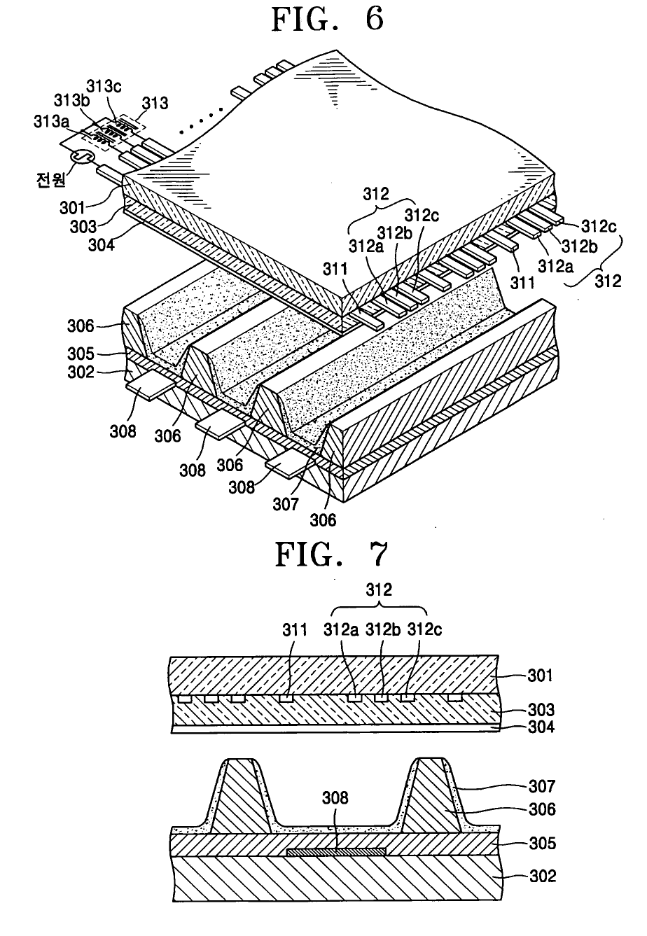

FIG. 6 is a schematic perspective view of a PDP according to another embodiment of the present invention.

The PDP includes first and second substrates 301 and 302, which define a discharge space. In addition, the discharge space is partitioned into a plurality of discharge cells by barrier ribs 306. A plurality of first and second electrodes 311 and 312 are disposed on an inner surface of the first substrate 301. The first and second electrodes 311 and 312 are made of a transparent material. The first and second electrodes 311 and 312 serve as discharge sustain electrodes, which are parallel to each other. A dielectric layer 303 and a protective layer 304 are stacked in this order on the first and second electrodes 311 and 312. The protective layer 304 is made of MgO.

The second electrode 312 is divided into a plurality of discharge elements. In the embodiment, three discharge elements 312a, 312b, and 312c are provided. A discharge delay unit 313 is coupled to the discharge elements 312a, 312b, and 312c. The discharge delay unit 313 includes three discharge delay elements 313a, 313b, and 313c coupled to the respective discharge elements 312a, 312b, and 312c. The discharge delay elements 313a, 313b, and 313c can be shared by other discharge cells.

On the other hand, since the closest discharge element 312a first initiates a discharge, the discharge need not be delayed. Therefore, the discharge delay element 313a coupled to the closest discharge element 312a can be omitted.

A plurality of the barrier ribs 306 are provided over an inner surface of the second substrate 302 in the direction perpendicular to the first and second electrodes 311 and 312. A plurality of address electrodes 308 are disposed on the inner surface of the second substrate 302 between the barrier ribs 306. A dielectric layer 305 is provided to cover the address electrodes 308. As shown in FIG. 7, fluorescent layers 307 are coated on side walls of the barrier ribs 306 and upper surfaces of the dielectric layer 305 between the barrier ribs 306. As shown in FIG. 6, the first and second electrodes 311 and 312 are disposed in the direction perpendicular to the address electrodes 308 and the barrier ribs 306. However, in FIG. 7, in order to show all the components in the single figure, the first and second electrodes 311 and 312 are depicted in the direction parallel to the address electrodes 308 and the barrier ribs 306.

The operation of the PDP according to the present invention is generally similar to that of a conventional PDP. The difference therebetween is the operation associated with the plurality of the discharge elements of the second electrodes 312 and the discharge delay elements coupled thereto.

When using the semiconductor switches as a discharge element, there is need for a driving circuit for the semiconductor switches. The driving circuit can be implemented by those of ordinarily skill in the art.

According to a discharge lamp and Plasma Display Panel (PDP) of the present invention, it is possible to initiatea discharge at a low discharge voltage and generate a sustain discharge through a long discharge path. Therefore, it is possible to reduce the production costs of the discharge lamp or the PDP. In addition, it is possible to improve the discharge efficiency due to the long discharge path.

In addition, a discharge mechanism according to the present invention can be used for a low-discharge-voltage high-efficiency apparatus such as a discharge lamp or a PDP.

While the present invention has been particularly shown and described with reference to exemplary embodiments thereof, it will be understood by those skilled in the art that various modifications in form and detail can be made therein without departing from the spirit and scope of the present invention as defined by the appended claims.

What is claimed is:

1. A flat discharge lamp, comprising:
a container;
first and second electrodes arranged in the container, the second electrode including a plurality of discharge elements having different respective discharge distances with respect to the first electrode; and
at least one discharge delay element respectively electrically connected to at least one of the plurality of discharge elements, each of the at least one discharge delay elements having different delay times.

2. The flat discharge lamp according to claim 1, wherein the at least one discharge delay element comprises a magnetic switch.

3. The flat discharge lamp according to claim 1, wherein a discharge delay element having a longest delay time is electrically connected to a discharge element having a greatest discharge distance with respect to the first electrode.

4. The flat discharge lamp according to claim 2, wherein a discharge delay element having a longest delay time is electrically connected to a discharge element having a greatest discharge distance with respect to the first electrode.

5. The flat discharge lamp according to claim 1, wherein the discharge delay elements are respectively electrically connected to the plurality of discharge elements such that the delay times of the discharge delay elements are proportional to the discharge distances with respect to the first electrode of the plurality of discharge elements.

6. The flat discharge lamp according to claim 2, wherein the discharge delay elements are respectively electrically connected to the plurality of discharge elements such that the delay times of the discharge delay elements are proportional to the discharge distances with respect to the first electrode of the plurality of discharge elements.

7. A Plasma Display Panel (PDP), comprising:
a discharge space;
first and second electrodes arranged in the discharge space, the second electrode including a plurality of discharge elements having different discharge distances with respect to the first electrode; and
at least one discharge delay element respectively electrically connected to at least one of the discharge elements, each of the at least one discharge delay elements having different delay times.

8. The PDP according to claim 7, wherein the at least one discharge delay element comprises a magnetic switch.

9. The PDP according to claim 7, wherein a discharge delay element having a longest delay time is electrically connected to a discharge element having a greatest discharge distance with respect to the first electrode.

10. The PDP according to claim 8, wherein a discharge delay element having a longest delay time is electrically connected to a discharge element having a greatest discharge distance with respect to the first electrode.

11. The PDP according to claim 7, wherein the discharge delay elements are respectively electrically connected to the plurality of discharge elements such that the delay times of the discharge delay elements are proportional to the discharge distances with respect to the first electrode of the plurality of discharge elements.

12. The PDP according to claim 8, wherein the discharge delay elements are respectively electrically connected to the plurality of discharge elements such that the delay times of the discharge delay elements are proportional to the discharge distances with respect to the first electrode of the plurality of discharge elements.
